(19) United States
(12) Patent Application Publication
(10) Pub. No.: US 2017/0345064 A1
(43) Pub. Date: Nov. 30, 2017

(54) ADVERTISEMENT BLOCKER CIRCUMVENTION SYSTEM

(71) Applicants: Mark Bauman, San Diego, CA (US); Ray Bonander, San Diego, CA (US)

(72) Inventors: Mark Bauman, San Diego, CA (US); Ray Bonander, San Diego, CA (US)

(21) Appl. No.: 15/424,735

(22) Filed: Feb. 3, 2017

Related U.S. Application Data
(63) Continuation-in-part of application No. 15/166,217, filed on May 26, 2016.

(51) Int. Cl. G06Q 30/02

(52) U.S. Cl. CPC G06Q 30/0277

(57) ABSTRACT

An advertisement blocker circumvention method has the steps of a user device requesting content from the content publisher, wherein the content is embedded with a circumvention loader and at least one advertising call, the circumvention loader detecting the presence of the adblocker, detecting presence of an advertisement blocker, unblocking blocked content, displaying an ask prompt on the user device, lifting restrictions, limiting access, and reinserting trackable resources. In an embodiment, unblocking blocked content comprises unblocking a user-selected portion of the blocked content. In a further embodiment, the ask prompt comprises a user-selectable option comprising “Block Ad”, “Block Ads,” and “Block All Ads.”

### CROSS-REFERENCE TO RELATED APPLICATION(S)

The present application is a continuation-in-part of, and claims priority to, U.S. patent application Ser. No. 15/166,217 filed on May 26, 2016, entitled “ADVERTISEMENT BLOCKER CIRCUMVENTION SYSTEM,” the entire disclosure of which is incorporated by reference herein.

### BACKGROUND OF THE INVENTION

### 1. Field of the Invention

The present invention is directed to online advertisement systems and, more particularly, to systems and methods for counteracting online advertisement.

### 2. Description of the Invention

Online advertising is an important revenue stream for many publishers of online content. Online advertising is also an important means through which different entities, products, and services generate goodwill, brand recognition, and customer loyalty as well as promote and disseminate information about those entities, products, and services.

Online advertisement may be, without limitation, in the form of banner, pop-up, embedded, in-line, interstitial, and full page canvas advertisements that are presented when a user visits a page, navigates away from a page, closes a page, or is otherwise directed to a page or an advertisement. The advertisements can be provided as links, audio content, or visual content including text, images, and other multimedia content.

Advertisement blocking tools, also referred to herein as adblockers, operate to block the display and, in some cases, the loading of online advertisements on websites, such as HyperText Markup Language (“HTML”) pages, and other downloadable content. Adblockers can be software applications, browser components, extensions, add-ons, scripts, or any service that operates in conjunction with a web browsing application, such as Chrome, Internet Explorer, and Firefox, for the purpose of blocking the display and/or loading of online advertisements.

Adblockers operate by intercepting calls to advertisements within content or preventing the advertisements from loading as part of the content. Typically, adblockers identify the advertisement calls that are to be intercepted using various blacklists or filters. The blacklist filters may specify links that identify various servers, services, or other sources of advertisements. The blacklisted links include Uniform Resource Locators (“URL”), other hyperlinks, keywords or addressing to known advertisements or advertising providers. The blacklisted classes include function calls, scripting language, and other code that are used to embed advertisements within content. Adblockers may also block specific Cascade Style Sheet (“CSS”) selectors, CSS styles, and HTML elements from loading or being included as part of the content presentation. These and many other techniques may be used by different adblockers, but their objective is the same, to prevent the display or loading of advertisements that are embedded within online content.

Adblockers therefore prevent the presentation of content as originally intended by the originating content publisher. In so doing, adblockers deprive the content publisher of advertising revenue and also prevent the marketing, promotion, and information dissemination of entities, products, and services. Accordingly, there is a need to counteract the effect of adblockers and ensure that content is presented on the user device in the manner intended by the originating online content publisher.

### SUMMARY OF THE INVENTION

An advertisement blocker circumvention system has the steps of a user device requesting content from the content publisher, wherein the content is embedded with a circumvention loader and at least one advertising call destined for a third-party server; the content publisher serving the content with the at least one advertisement call and the circumvention loader to the user device; the user device constructing a DOM hierarchy by parsing the content into object components; an adblocker intercepting and blocking the one or more advertisement calls; the circumvention loader detecting the presence of the adblocker; the circumvention loader identifying ad placements and issuing an obfuscated advertisement call containing an original advertising call, to a circumvention proxy that is a reverse proxy; the circumvention proxy extracting an advertisement call from the obfuscated advertising call, and issuing the advertisement call to receive the advertisement; the circumvention proxy providing the advertisement to the circumvention loader; and the circumvention loader displaying the ad on the user device.

The system may have a circumvention loader detecting the presence of the adblocker by attempting to load a third-party advertisement tag that is tracked, or may detect the presence of the adblocker by attempting to load a third-party advertisement tag that contains a trackable resource.

The circumvention proxy may encode the advertisement before sending it to the circumvention loader, and inserting the advertisement comprises modifying a Document Object Model (“DOM”) hierarchy by inserting the advertisement into the DOM hierarchy. An additional step of the user device rendering the content based on the modified DOM hierarchy, wherein rendering the content based on the modified DOM hierarchy comprises displaying the advertisement with the content on the user device may be used. The content may be obfuscated using methods including but not limited to Base64 encoding, SHA256 or MD5 hashing algorithms. Detecting the presence of the advertisement blocker may involve identifying absence of a particular call in rendering of the downloadable content, wherein the particular call is specified as part of the downloadable content. The configuration of the circumvention loader to execute upon firing of a load event during processing of the content by the user device.

Obfuscated content may be encoded using a 64-bit encoding. Encoding the first advertisement may involve encoding an address to the first destination and an identifier for the advertisement as part of the encrypted string issued with the second call. Detecting presence of the advertisement blocker on the user device may involve scanning a plurality of nodes of a DOM hierarchy created from parsing each object of the downloadable content and identifying absence of the content loaded by a particular resource.

Encoding the first advertisement call may involve specifying a Uniform Resource Locator (“URL”) with a domain name directed to the second destination and a path comprising the encoded string containing an encoded address to the first destination.

The system may have the further step of constructing the DOM hierarchy for the content, wherein constructing the DOM hierarchy involves invoking the advertisement blocker and blocking the advertisement call to the first destination based on the first destination being blacklisted by the advertisement blocker. The advertisement call may be extracted from the circumvention proxy is different from the original advertisement call, and the advertisement call may be extracted from the circumvention proxy calls a different ad than the original advertisement call.

The advertisement blocker circumvention method comprising the steps of detecting presence of an advertisement blocker, unblocking blocked content, displaying an ask prompt on the user device, lifting restrictions, limiting access, and reinserting trackable resources. In an embodiment, unblocking blocked content comprises unblocking a user-selected portion of the blocked content. In a further embodiment, the ask prompt comprises a user-selectable option comprising “Block Ad”, “Block Ads,” and “Block All Ads.”

In an embodiment, limiting restrictions comprise lifting restrictions on a plurality of blocked content. Limiting access comprises limiting access to a plurality of detected content. Reinserting trackable resources comprises inserting resources into the step of displaying an ask prompt on the user device.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a messaging diagram of the advertisement blocker circumvention system, according to an embodiment of the present invention;

FIG. 2 is a flowchart view of the advertisement blocker circumvention system, according to an embodiment of the present invention;

FIG. 3 is a messaging diagram of an alternative embodiment of the advertisement blocker circumvention system, according to an embodiment of the present invention; and

FIG. 4 is a flow-chart diagram of an alternative embodiment of the advertisement blocker circumvention system, according to an embodiment of the present invention.

### DETAILED DESCRIPTION OF PREFERRED EMBODIMENTS

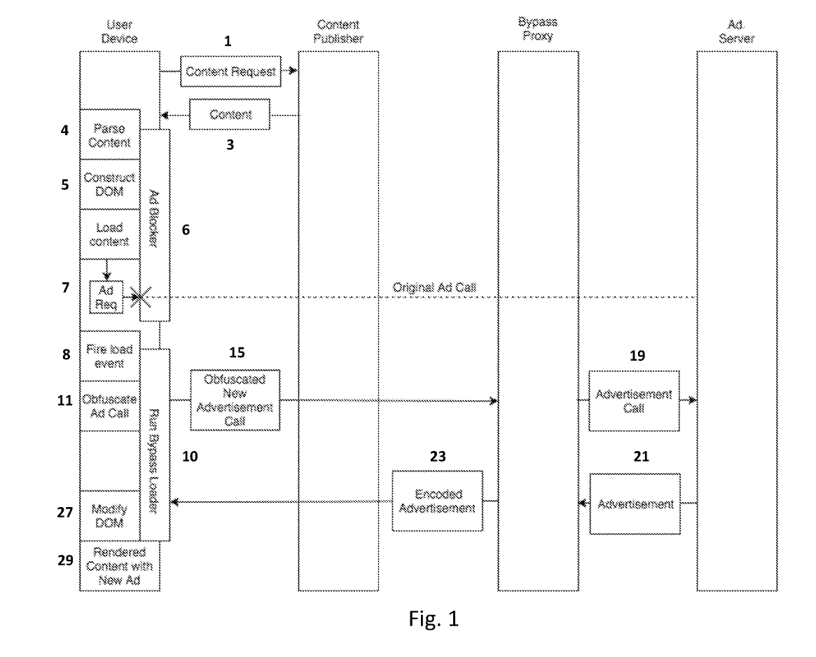

Preferred embodiments of the present invention and their advantages may be understood by referring to FIGS. 1-4, wherein like reference numerals refer to like elements.

In the following detailed description, numerous details, examples, and embodiments for the adblocking circumvention system are set forth and described. The adblocking circumvention system is not limited to the embodiments set forth, and it may be practiced without some of the specific details and examples discussed. Also, reference is made to the accompanying figures, which illustrate specific embodiments in which the adblocking circumvention system can be practiced. It is to be understood that other embodiments can be used and structural changes can be made without departing from the scope of the embodiments herein described.

With reference to FIG. 1, content publishers, such as websites, provide content for consumption by user devices such as computers, smartphones, tablets, in-car and in-flight entertainment systems and other devices. Content is a general term referring to any web site, text, document, file, media, application, service, or game that is digitally encoded and is deliverable across a network, such as the Internet. Content itself can be composed of content sub-components, wherein the sub-components may be provided by the same content publisher or different content publishers. For instance, content may be embedded with images provided by a first content publisher, a service provided by a second content publisher, and advertisements provided by one or more advertisement servers. In FIG. 1, the content publishers operate a plurality of servers that host and deliver their content, which may also be hosted and served from other sources including content delivery networks (“CDNs”), cloud service providers, and caching or proxy servers operated by third parties independent of the content publishers.

A user device, which typically comprises a processor, input means and a screen, displays content for the appreciation of the user. Examples of user devices are smartphones and computers, typically network-connected. Typically the content is retrieved from a network, such as the Internet, and displayed for the user, and embedded content from third parties, such as ads, may be shown to the user in conjunction with the content. As some users prefer to avoid ads that are shown together with content, some user may install an adblocker to identify and remove ads being served with the content.

Advertisement servers are machines that host and deliver advertising content that may be embedded within the content publisher content. The content publisher selects whether to make any advertisement calls, wherein the ads are not a part of the content of the page but are provided from ad servers, separate from the content. The content typically provides for the location and other characteristics of the advertising content. When a user device receives and processes content with one or more advertisement calls, the user device will parse and invoke those advertisement calls in order to identify and retrieve the advertisements from the appropriate ad servers. The content is stored and later retrieved in a storage media location, and, generally, CPU registers while it is processed. The advertisements are then rendered or displayed as part of the content in the manner configured or specified within the content publisher content.

Although the process is more or less unnoticed by the casual user, except for the appearance of the ads, the communication protocol is actually fetching content from a number of disparate servers, and adblocking software typically works by intercepting calls to certain “blacklisted” domains that are known advertising servers. Adblockers may use filter lists, which are essentially an extensive set of rules that tell the adblocker which elements of a website to block. The user may edit or add a filter list, which may contain a standardized ad-blocking list selected based on a particular language, or an “acceptable ads” list based on arbitrary criteria.

The advertising blocker identifies and intercepts these advertisement calls. Some software substitutes other ad material for the removed ad, inserts a blank ad, or reformats the page to removes the space allocated to ads from the page. In one embodiment, adblockers may substitute other advertising or content for the restricted ad. Adblockers may accept payment from larger companies to selectively unblock ads from those companies' adservers. Some adblockers receive a licensing fee for “whitelisting” services, wherein meeting an “acceptable ads” policy may be a requirement.

A circumvention proxy and one or more circumvention loaders of the present invention are intended to reverse the removal of ads by the adblocker, adding in other advertisements that were not originally embedded in the content. In some embodiments, the circumvention loaders are embedded in the site as client-side and server-side scripts that dynamically adapt in response to adblocker operation. The circumvention loader monitors which advertisement calls are blocked, and determines how the adblocker blocks ads and which ads are blocked. The circumvention loader modifies the manner in which the advertisements associated with those advertisement calls are retrieved to prevent the adblocker from identifying those advertisements for removal. For example, if the ads are issuing from a particular ad server which is blocked by the adblocker, the circumvention loader detects the presence of an ad blocker and programmatically replaces the blocked ads. It uses a script to identify where the ads should be blocked and programmatically replaces the ads to avoid the blocking action. In some embodiments, a call or function embedded within the content publisher content is used to invoke a second circumvention loader on a machine that is local or remote or both to the user device issuing the call or function. In some embodiments, the circumvention loader is configured to execute on the “load” or “onLoad” Document Object Model (“DOM”) or HyperText Markup Language (“HTML”) event fires. These events fire when a page, object, or entirety of the content has “finished” loading on the corresponding user device, signaling the ability to detect the presence of an adblocker.

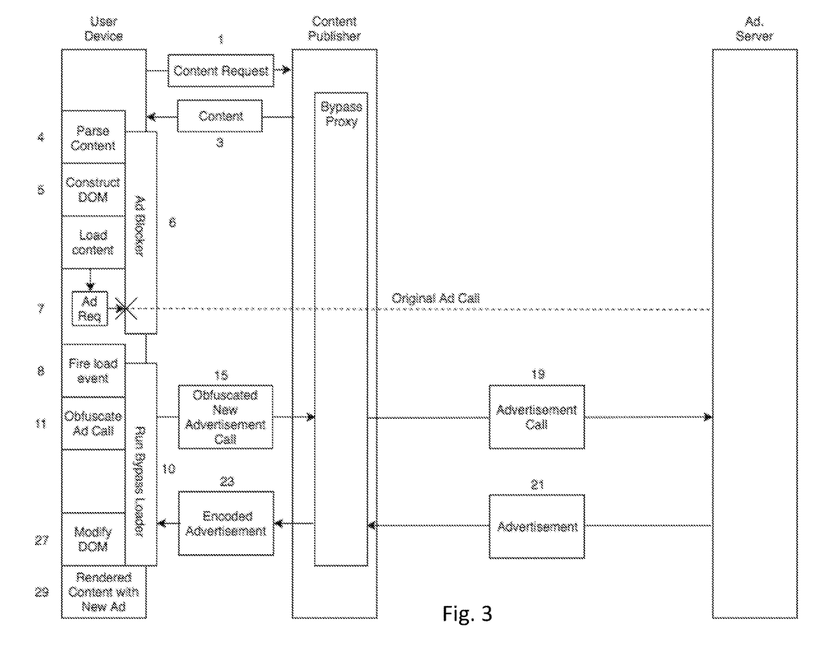

The circumvention proxy is a network accessible machine that operates in tandem with the user devices and content publishers, although the circumvention proxy functionality can be incorporated directly into content publisher servers, as seen in FIG. 3. Each circumvention proxy is a service that may be hosted by both the publication and the adblocking circumvention system. Incorporating the circumvention proxy functionality directly within servers or other resources (e.g., load balancers) of the content publisher(s) is preferable for adblockers that prevent user devices from issuing calls to any third party servers when rendering first party content. Since all content, including ad content, emanates from the same authorized content server, the adblocker is unable to separate the content and selectively block the ads. The circumvention proxy is in fact a reverse proxy, which receives the ad materials from the third party ad server and produces them to the user's device. Before the ad materials are displayed, they are stored and retrieved from a storage media location, and within CPU registers while the ad material is being processed by the CPU. A benefit to a reverse proxy being located on the content publisher's server is that the ad material appears to emanate from the content publisher. As the content and proxy are on the same address, the adblocker does not detect ad content, and cannot distinguish ad content from the non-ad content.

FIG. 1 presents a message exchange diagram illustrating showing the adblocking circumvention system in operation, wherein advertisements are loaded and presented on a user device running an adblocker. In this figure, messages are exchanged between a user device, content publisher, advertisement server, and circumvention proxy. The user device runs an adblocker in conjunction with a browsing application.

In step 1 the user device requests content from the content publisher. In this example, the content is embedded with the circumvention loader, as well as at least one advertising call that is to be made to a third-party ad server. The link can be a Uniform Resource Locator (“URL”) having a domain name or Internet Protocol (“IP”) address of the advertisement server, a directory path, and a filename of the advertisement. In response to the user device request, at step 3 the content publisher serves the requested content with at least one advertisement call as well as the embedded circumvention loader, to the user device. As the browser parses the content page in step 4, and at step 5 it constructs the DOM hierarchy. Construction of the DOM hierarchy an operation performed by most content browsing applications including web browsers that involves parsing the content into its various object components and producing a tree with nodes to represent the object components, style, and structure in a manner that is accessible through an API.

While parsing the content and constructing the DOM hierarchy, at step 6 the adblocker intercepts any advertisement calls for third party servers that are embedded in the content and to prevent the loading of those third-party advertisements, effectively blocking the communication with the ad server. The adblocker may filter advertising calls based on a URL, domain name, hostname, or other address that matches to an entry in the adblocker blacklist. In one embodiment, adblockers work by parsing a filter list that has pre-defined strings representative of the advertising tags in the HTML code of the web page. They act like a list of directions for the browser extension. Here are some of the functions that a filter can delegate to the extension: i) URL blocking, namely not allowing a request to be made by the browser; ii) element hiding, namely blocking elements via CSS or inline styling; and iii) blocking by request type, e.g.: xmlhttprequest, script, stylesheet, and image tags.

In an embodiment, the adblocker may also indirectly identify advertisement calls by blocking specific Cascade Style Sheet (“CSS”) selectors and HTML elements from being added to the DOM hierarchy. For example, the adblocker can intercept and prevent loading or display of advertisements by removing or hiding nodes from the DOM hierarchy that arise because of various advertisement calls. In such situations, at step 7 the user device may actually issue the advertisement calls with the adblocker later preventing them from being loaded or removing them once they are loaded as part of the content. Other adblockers may prevent the DOM hierarchy from being constructed with any advertisement related nodes. In such situations, the adblockers prevent the user device from even issuing the advertisement calls to the corresponding advertisement server. As a result of the ad blocking, spaces where the ads were intended to appear may be blank or folded into the remaining space.

Once the content is parsed and the DOM hierarchy is constructed, in step 8 the load event fires. The load event signals the termination of the operation of the ad blocker as well. The firing or completion of the load event triggers execution of the circumvention loader that is also embedded as part of the content publisher content. The circumvention loader detects for the presence of any adblocker running on the user device. The detection can be performed in any number of ways including attempting to load a specific third-party advertisement tag that is itself tracked or contains a trackable resource. If an adblocker is running, the advertisement call will not return the advertisement information, the absence of which confirms to the circumvention loader that the adblocker is still running. Through CSS, Pops, Display, and various other methods the system determines if an ad blocker is running. Checking to see if ad content was blocked as opposed to checking to see what is not blocked, can return false positives. Therefore the system uses both means for checking. The circumvention loader is run at step 10 and identifies the advertisement calls that were intercepted and blocked by the adblocker. In some embodiments, the circumvention loader identifies the advertisement calls by checking for any blocks, as well as for content loaded by an advertisement that is staged to be blocked by the ad blocker. The circumvention loader then identifies any ad placements and at step 11 issues an obfuscated advertisement call to the circumvention proxy. In some embodiments, the circumvention proxy address is continually changed to ensure that the address is not within the adblockers' filter lists. As such, the advertisement calls will not be blocked. However, some adblockers prevent calls to any third party domains including the domain specified in the circumvention proxy address. To overcome such restriction, some embodiments direct the obfuscated advertisement call to an address of a load balancer or other server operated by the first party content publisher. The load balancer or other server is configured to forward the calls to the circumvention proxy or perform the circumvention proxy operation by incorporating the circumvention operation functionality within the first party content publisher's own servers.

In step 15 the circumvention proxy receives an obfuscated advertisement call. In some embodiments, the obfuscated advertisement call includes the original advertisement call but not the original link, used in requesting the advertisement from the advertisement server. Accordingly, in step 17 the circumvention proxy extracts the original advertisement call from the obfuscated advertisement call, and in step 19 issues the original advertisement call, and as a reverse proxy receives the original advertisement from a third-party advertisement server in step 21. As a reverse proxy, the circumvention proxy takes requests from the advertising servers, and forwards them to one or more circumvention proxy servers within the internal network. User devices making requests to the proxy are not aware of the internal network retrieving advertising content. In step 23 the circumvention proxy encodes and forwards the advertising to the circumvention loader running on the user device. The encoded advertising is less likely to be intercepted by an operational adblocker on the user device, since the adblocker is unable to decipher and interpret the content. In an embodiment, the obfuscation method can be, but is not limited to Base 64 encoding, SHA 256, MD5 and other hashing algorithms known in the art, as well as other 1-way and 2-way encoding/encryption. In one embodiment, in step 25 the encoded content is then returned after a request from an encrypted URL string via a primary check on whether specific content matches content on the filter list, and whether it is blocked by an adblocker and whether the advertisements exist and were delivered. In an embodiment, the encrypted content is called via Javascript, which contains pre-defined Javascript, wherein the encrypted content is not blocked by the advertisement blocker, and the issuing of the second call comprises inserting of HTML via Javascript. An ad blocker can come to life after the load event fires, and can block in other ways, as well as refining the ad block methodology. An adblocker cannot reblock without updating its system instantaneously while targeting the method of circumvention. An adblocker could re-block after checking a first time, after having terminated.

In an embodiment, the circumvention loader forwards advertisement from a third party to replace the advertising that was blocked by the adblocker, and may forward the advertisement in a way that is not white listed or a technology detected by ad blockers.

In some embodiments, the circumvention proxy may cache a copy of the advertisement content such that future requests for that advertisement can be satisfied from cache without having to access the advertisement server. A time-to-live parameter may be provided to invalidate the cached copy of the advertisement and cause the circumvention proxy to retrieve another copy of the advertisement from the advertisement server upon its expiration.

In step 37, the circumvention loader reintroduces the advertisement that the adblocker removed (or a new advertisement) back into the presentation or rendering of the content. In some embodiments, the circumvention loader reintroduces the original advertisement, or introduces a new advertisement, by manipulating the DOM hierarchy in step 27. In some embodiments, manipulating the DOM hierarchy involves inserting a node for the advertisement into the hierarchy with the attributes specified by the content provider for presenting the advertisement as part of the content rendering. The user device resumes its normal operation and renders the content based on the modified DOM hierarchy in step 29. The rendered content includes the original content with the addition of the newly added advertisement. Since the adblocker has terminated, it does not act on the re-rendering of the content.

The circumvention proxy also accesses the copy of the content stored by the content publisher in order to modify the advertisement call in the content. In some embodiments, the modification involves changing the source address or link of the advertisement call within the content to a modified address or link that is not within the adblocker blacklist. In some embodiments, the modification involves changing the advertisement call from requesting the advertisement from the advertisement server to requesting the advertisement from the circumvention proxy (within the content provider server network) with the original request to the advertisement server being encrypted and included as part of the modified advertisement call. Different aliases or addresses for the circumvention proxy can be used to ensure that the adblockers do not prevent access of the user device to the circumvention proxy. In one embodiment, the address of the circumvention proxy changes frequently to avoid blacklisting or make blacklisting by the adblocker more difficult.

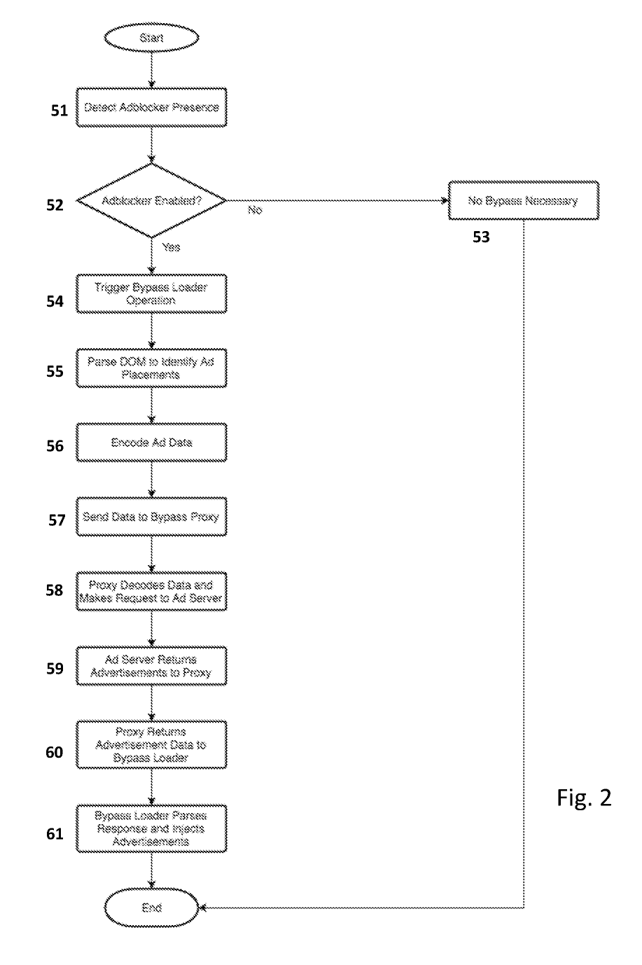

FIG. 2 describes the steps of a method for hiding the actual address of the advertisements from the adblocker. In steps 51 and 52, the system determines if the adblocker is present and enabled. If not enabled, at step 53 no bypass is necessary and the system terminates. If the adblocker is enabled, it triggers the circumvention loader operation. In step 55, the DOM is parsed to identify ad placements. In step 56, the ad data is encoded. For each ad placement defined in the circumvention loader, the circumvention loader will check the DOM for the existence of that ad placement and send the relevant data to the circumvention proxy at step 57. Data is encoded by the circumvention proxy and sent back containing more encoded data for the bypass proxy to load the called advertisements at step 58. In step 59, the ad server returns advertisements to the circumvention proxy. In step 60, the circumvention proxy returns the advertisement data to the circumvention loader, and in step 61 the circumvention loader parses the response and injects the advertisements into the content.

Adblockers may block advertising calls based on the address of the server to which the call is made, wherein calls to third-party servers are blocked, regardless of the content of the call. In this case, the circumvention proxy may be located on the content provider site, within the content provider's network, or within a content provider's load-balancing network, so as to provide advertising content with the same source address as the content itself, thus limiting blocking of the content by adblockers.

The circumvention proxy reverses the circumvention loader operations to extract the original advertisement call from the obfuscated advertisement call, request the advertisement from the appropriate advertisement server using the original advertisement call, and return the advertisement to the circumvention loader.

In some embodiments, the circumvention proxy preserves the ability of the advertisement server to track the user devices that receive the advertisements served by the advertisement server. To do so, when the circumvention proxy issues the original advertisement call to the advertisement server, the circumvention proxy forwards the user device information to the advertisement server to enable the advertisement server to track the true recipient for the advertisement. Similarly, when forwarding the advertisement back to the circumvention loader, the circumvention proxy can submit the advertisement with the header provided by the advertisement server, which may include a cookie or other tracking information.

In order to overcome CSS blocking on the part of the adblocker, the system may create new content or edit css properties. In order to bypass the filter list(s) utilized by different Ad Block technologies, a series of DNS “A” records or CNAMES' can be utilized to quickly change the domain in which ads are served under.

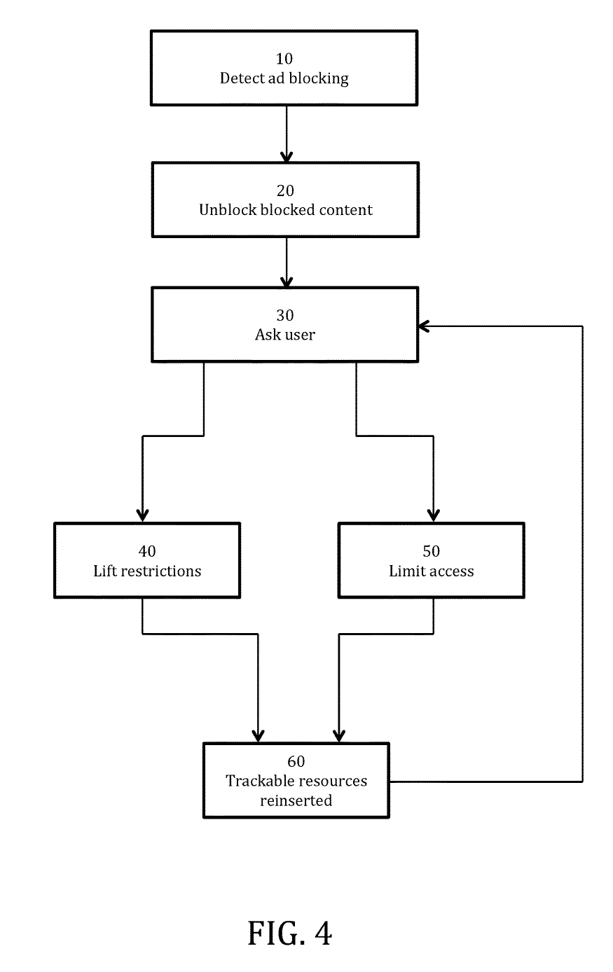

In another embodiment of the present disclosure and with reference to FIG. 4, the method may further comprise the steps of detecting ad blocking, unblocking blocked elements, asking a user, and lifting or limiting access (detecting, unblocking asking or lifting, hereinafter “DUAL”).

In another embodiment of the present invention and with reference to FIG. 4, in step 10, the method detects ad blocking (a “detect” step). In one embodiment, the detection can be performed in a variety of ways including attempting to load a specific third-party advertisement tag that is tracked or contains a trackable resource. If an adblocker is running, the advertisement call will not return the advertisement information, the absence of which confirms to the circumvention loader that the adblocker is still running. Through CSS, Pops, Display, and various other methods, the system determines if an ad blocker is running.

In another embodiment of the present invention and with reference to FIG. 4, in step 20, the method unblocks blocked content (an “unblock” step). In one embodiment, the method unblocks all blocked content. In another embodiment, the method unblocks a portion of the blocked content based on the user's preset selections or on the user's past selections. The unblocked content appears on the user's view of the website.

In another embodiment of the present invention and with reference to FIG. 4, in step 30, the method includes a user-selectable option to re-implement an ad blocker after advertisement reinsertion, accomplished by prompting the user though an on-screen prompt (an “ask” step). An associated message may indicate that unblocking ads will provide revenue for the website providing the content. In one embodiment, the user is presented with various prompts including “Block Ads,” “Block Ad,” and “Block All Ads.” “Block Ad” sends a call back to a central data storage, such as an ad server or database with the users selection to record the action and create instances for ad blockage of that ad indicated. “Block All Ads” blocks all ads on the page, rather than just a single ad indicated. “Report Ads” reports the file or ad associated with the option selectors back to a central data storage and creates instances of reblocking of the ad. “Terms and Conditions” follow the same process of reinsertion and reports the file or ad associated with the option selectors back to a central data storage, and follows a programmed rule associated with the selector.

In another embodiment, the method loads a primary, secondary, third-party, or other levels of advertisement tags that contains a trackable resource when the user is prompted. In another embodiment, the method may send a call back to a central data storage device, such as an ad server or database with the user's selection to record the action and create instances for ad blockage of the ad indicated. In another embodiment, the call back may specify a URL with a domain name directed to the second destination and a path comprising the encoded string containing an encoded address to the first destination with specific events attached to it. In another embodiment, the method may block all ads on a page wherein the method blocks all ad content if selected by the user. In another embodiment, the method may report ads wherein the method reports the file or ad associated with the option selectors back to a central data storage and create instances of reblocking of the specific ad.

In another embodiment of the present invention and with reference to FIG. 4, in step 40, the method lifts restrictions on specific ads selected by the user. In another embodiment, the method lifts restrictions of specific ads based on a the user's past selections reported to, stored on, and retrieved from a remote database.

In another embodiment of the present invention and with reference to FIG. 4, in step 50, the method limits access on specific ads selected by the user. In another embodiment, the method limits restrictions of specific ads based on a the user's past selections reported to, stored on, and retrieved from a remote database.

In another embodiment of the present invention and with reference to FIG. 4, in step 60, trackable resources are reinserted. In one embodiment, trackable resources comprise track information such as views and clicks, as well as create events based on the users choice. In another embodiment, the method displays “Terms and Conditions” message to the user. In another embodiment, the method may report the file or ad associated with the option selectors back to a central data storage or a remote data storage unit and follows the stored rule associated with the selector based on the user's past selections. These events are ad reinsertions similar to step 30. The reinsertions use the same process, encoding, and other factors, as the advertisement call itself, to call the options and events. The advertisement call may involve specifying a Uniform Resource Locator (“URL”) with a domain name directed to the second destination and a path comprising the encoded string containing an encoded address to the first destination with specific events attached to it.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. An advertisement blocker circumvention method, comprising:
a. a user device requesting content from the content publisher, wherein the content is embedded with a circumvention loader and at least one advertising call destined for a third-party server;
b. the content publisher serving the content with at least one advertisement call and the circumvention loader to the user device;
c. the user device contracting a DOM hierarchy by parsing the content into object components;
d. an adblocker intercepting and blocking the one or more advertisement calls;
e. the circumvention loader detecting the presence of the adblocker;
f. the circumvention loader identifying advertising placements and issuing an obfuscated advertisement call containing an advertising call, to a circumvention proxy that is a reverse proxy;
g. the circumvention proxy extracting an advertisement call from the obfuscated advertising call, and issuing the advertisement call to receive the advertisement;
h. the circumvention proxy providing the advertisement to the circumvention loader;
i. the user device storing the advertisement on a storage media location;
j. the circumvention loader displaying the advertisement on the user device after extracting the advertisement data from a storage media location;
k. unblocking blocked content;
l. displaying an ask prompt on the user device;
m. lifting restrictions;
n. limiting access; and
o. reinserting trackable resources.

2. The advertisement blocker circumvention method of claim 1, wherein the circumvention loader detects the presence of the adblocker by attempting to load a third-party advertisement tag that is tracked.

3. The advertisement blocker circumvention method of claim 1, wherein the circumvention loader detects the presence of the adblocker by attempting to load a third-party advertisement tag that contains a trackable resource.

4. The advertisement blocker circumvention method of claim 1, wherein inserting the advertisement comprises modifying a Document Object Model (DOM) hierarchy by inserting the advertisement into the DOM hierarchy.

5. The advertisement blocker circumvention method of claim 1, wherein detecting the presence of the advertisement blocker comprises identifying absence of a particular call in rendering of the downloadable content, wherein the particular call is specified as part of the downloadable content.

6. The advertisement blocker circumvention method of claim 1, wherein detecting presence of the advertisement blocker on the user device comprises scanning a plurality of nodes of a DOM hierarchy created from parsing each object of the downloadable content and identifying absence of a particular node(s) content for the advertisement from the plurality of nodes of the DOM hierarchy.

7. The advertisement blocker circumvention method of claim 1, wherein the advertisement call extracted from the circumvention proxy is different from the original advertisement call.

8. The advertisement blocker circumvention method of claim 1, wherein unblocking blocked content comprises unblocking a user-selected portion of the blocked content.

9. The advertisement blocker circumvention method of claim 1, wherein the ask prompt comprises a user-selectable option comprising “Block Ad”, “Block Ads,” and “Block All Ads.”

10. The advertisement blocker circumvention method of claim 1, wherein limiting restrictions comprise lifting restrictions on a plurality of blocked content.

11. The advertisement blocker circumvention method of claim 1, wherein limiting access comprises limiting access to a plurality of detected content.

12. The advertisement blocker circumvention method of claim 1, wherein reinserting trackable resources comprises inserting resources into the step of displaying an ask prompt on the user device.

13. The advertisement blocker circumvention method comprising the steps of:
a. detecting presence of an advertisement blocker;
b. unblocking blocked content;
c. displaying an ask prompt on the user device;
d. lifting restrictions;
e. limiting access; and
f. reinserting trackable resources.

14. The advertisement blocker circumvention method of claim 13, wherein unblocking blocked content comprises unblocking a user-selected portion of the blocked content.

15. The advertisement blocker circumvention method of claim 13, wherein the ask prompt comprises a user-selectable option comprising “Block Ad”, “Block Ads,” and “Block All Ads.”

16. The advertisement blocker circumvention method of claim 13, wherein limiting restrictions comprise lifting restrictions on a plurality of blocked content.

17. The advertisement blocker circumvention method of claim 13, wherein limiting access comprises limiting access to a plurality of detected content.

18. The advertisement blocker circumvention method of claim 13, wherein reinserting trackable resources comprises inserting resources into the step of displaying an ask prompt on the user device.
